(19) United States
(12) Patent Application Publication
(10) Pub. No.: US 2025/0249761 A1
(43) Pub. Date: Aug. 7, 2025

(54) Support Device for an Accumulator Component With Protective Strip

(71) Applicant: Bayerische Motoren Werke Aktiengesellschaft, Muenchen (DE)

(72) Inventors: Savo ASANIN, Muenchen (DE); Franz BONAUER, Unterschleissheim (DE); Matthias REIL, Muenchen (DE); Martin SPAETH, Muenchen (DE)

(21) Appl. No.: 18/854,420

(22) PCT Filed: Apr. 13, 2023
(86) PCT No.: PCT/EP2023/059658

§ 371 Date: Oct. 4, 2024

(30) Foreign Application Priority Data
May 9, 2022 (DE) 10 2022 111 451.1

(51) Int. Cl. B60L 50/64; H01M 50/209; H01M 50/224; H01M 50/249; H01M 50/262; H01M 50/358

(52) U.S. Cl. CPC B60L 50/64; H01M 50/209; H01M 50/224; H01M 50/249; H01M 50/262; H01M 50/358; H01M 2220/20

(57) ABSTRACT

The invention relates to a support device for at least one accumulator component of a traction accumulator, which is designed to hold the at least one accumulator component vertically above and horizontally only partially overlapping with at least one cell module of the traction accumulator in an accumulator housing of the traction accumulator. In some implementations, the support device comprises: a holding frame configured to receive the at least one accumulator component; a hot gas trapping device having at least one protective strip for covering the top of the degassing region, which is designed to trap any hot gas escaping from the degassing region of at least one cell of the cell module and to keep it away from the at least one accumulator component.

### BACKGROUND AND SUMMARY

The present disclosure relates to a support apparatus for at least one accumulator component of a traction accumulator, which is designed to hold at least one accumulator component vertically above and horizontally only partially overlapping at least one cell module of the traction accumulator in an accumulator housing of the traction accumulator. The present disclosure also relates to a traction accumulator and to a motor vehicle.

In the present case, interest is directed to traction accumulators for electrically drivable motor vehicles, which may be in the form of, for example, high-voltage energy stores. Such traction accumulators usually have a multiplicity of accumulator components, for example cell modules and control units, which are arranged in an accumulator housing of the traction accumulator. The cell modules have a multiplicity of cells, which in turn have degassing elements for discharging a hot gas resulting from a fault from a cell housing of the cells. The degassing elements may be arranged, for example, on cell housing covers of the cell housing, which form an upper side of the cell module. The upper side of the cell module therefore has a degassing region formed of the cell degassing elements.

If, in the case of a multiple level traction accumulator, a further accumulator component is arranged vertically above such a cell module, in the event of a fault of at least one cell of the cell module underneath it, this accumulator component is subjected to the hot gas from said at least one cell. This leads to high thermal loading of the accumulator component. A particle flow transported by the hot gas can also result in mechanical loading of the accumulator component. Accumulations of these particles can additionally reduce air gaps and creep paths and thus increase the risk of short circuits in the accumulator component.

An object of the present invention is to easily and reliably protect accumulator components of a traction accumulator of a motor vehicle against adverse effects of a discharge of hot gas.

This object is achieved according to forms of the invention by a support apparatus, a traction accumulator, and a motor vehicle having the features according to the respective independent claims. The dependent claims, the description and the figures relate to advantageous embodiments of the invention.

A support apparatus according to the invention for at least one accumulator component of a traction accumulator is designed to hold the at least one accumulator component vertically above and horizontally only partially overlapping at least one cell module of the traction accumulator in an accumulator housing of the traction accumulator. The support apparatus comprises a holding frame for receiving the accumulator component and for partially overlapping an upper side of the at least one cell module in a manner horizontally offset from a degassing region, which is on the upper side, of the at least one cell module. Furthermore, the support apparatus comprises a hot-gas collecting device. This hot-gas collecting device comprises at least one protective strip, which is fastened to the holding frame, protrudes from an outer side of a frame strip of the holding frame, which is to say protrudes substantially horizontally, and extends at least partially along the frame strip, for covering the degassing region. The at least one protective strip is designed to collect a hot gas exiting the degassing region from at least one cell of the cell module and to keep it away from the at least one accumulator component.

The present disclosure also relates to a traction accumulator for a motor vehicle. The traction accumulator comprises at least one cell module having a multiplicity of cells, a degassing region with cell degassing elements for discharging a hot gas from a cell housing of the cells being located on an upper side of the cell module. The traction accumulator also has at least one accumulator component and a support apparatus according to forms of the invention, the at least one accumulator component being arranged in the holding frame and partially overlapping the upper side of the cell module in a manner horizontally offset from the degassing region. The at least one protective strip of the hot-gas collecting device is vertically spaced from and horizontally overlaps the degassing region and thus covers the degassing region.

The traction accumulator is in particular a high-voltage energy store. In particular, the cells of the cell module of the traction accumulator are in the form of prismatic cells, which each have a flat-cuboidal cell housing. The at least one cell module is in the form of a cell stack composed of the prismatic cells stacked in a stack direction. The stack direction may correspond, for example, to a vehicle transverse direction when the traction accumulator is arranged in the motor vehicle. The cell housings of the cells each have degassing elements, for example rupture membranes, which form the degassing region on the upper side of the cell module. In the case of the cell stack, this degassing region is in the form of a strip and extends along the stack direction.

The traction accumulator has multiple levels and has the at least one cell module, arranged in a first plane or a first level in the accumulator housing, and at least one accumulator component, which is arranged in a second plane vertically, or in the height direction, above it. The at least one cell module may be arranged, for example, on a bottom region of a housing lower part of the accumulator housing. The at least one accumulator component is in particular a further cell module. The at least one accumulator component may, however, also be a controller, for example.

The at least one accumulator component is offset from the at least one cell module vertically above it and horizontally transversely to the stack direction, for example along a vehicle longitudinal direction, with the result that a lower side of the accumulator component and the upper side of the cell module only partially overlap. The accumulator component does not overlap the degassing region and is thus arranged horizontally to the side of the degassing region. The degassing region thus extends underneath and next to the accumulator component. The support apparatus is provided to hold the accumulator component in the second plane, or in the second level. This support apparatus has the holding frame, which surrounds or encloses the accumulator component. The holding frame in particular does not have a bottom, and therefore the lower side of the accumulator component is exposed. The holding frame may be fastened, for example by means of feet-like support elements of the support apparatus, to a housing part of the accumulator housing, for example the housing lower part. For example, the holding frame may be fastened to strip-like holding struts of the accumulator housing, to which the at least one cell module of the first plane can also be fastened.

The holding frame is preferably in the form of a cast aluminum structure. The holding frame has in particular two frame strips which extend in the stack direction, are at a spacing from one another transversely to the stack direction and form longitudinal sides of the rectangular holding frame, and two frame strips which extend transversely to the stack direction, are at a spacing from one another in the stack direction and form short sides of the holding frame. The short-side frame strips face in particular toward side walls of the accumulator housing. One of the long-side frame strips extends overlapping the upper side of the cell module and is thus adjacent to the degassing region.

In the event of a fault, for example when there is a short circuit within at least one cell of the cell module in the first plane, this cell discharges a hot gas into an interior space of the accumulator housing via its degassing element. This hot gas rises vertically and transports heat and particles toward the at least one accumulator component. In order to prevent the hot gas from rising unobstructed toward the accumulator component and possibly damaging it, the support apparatus has the hot-gas collecting device, in short a hot-gas collector. The hot-gas collector has the at least one protective strip which is fastened to the holding frame. The protective strip is in the form of in particular a stamped and bent sheet-metal part, for example made of sheet steel. The at least one protective strip protrudes substantially horizontally, which is to say level or slightly inclined, from the frame strip adjacent to the degassing region and thus forms a cap-like covering which at least partially covers the underlying degassing region. The at least one protective strip at least partially collects the rising hot gas and thus reduces, in particular prevents, the ingress of heat and particles into the accumulator component. This advantageously makes it possible to prevent thermal and mechanical loading of the accumulator component and short circuits on the accumulator component.

The at least one protective strip is fastened to the holding frame by means of screws. To this end, the holding frame has for example horizontally protruding tabs with through-openings, through which a respective screw can be guided. The at least one protective strip may have rivet nuts in which the screws are screwed, with the result that the at least one protective strip is fastened to and suspended from the holding frame.

It has been found to be advantageous when the at least one protective strip is designed to carry the hot gas along the frame strip toward an end face, arranged in the region of an end of the frame strip, of the protective strip and thus discharge it to the side of the support apparatus. For example, the at least one protective strip for conducting the hot gas along the frame strip is in the form of a U profile. Owing to the U profile shape of the at least one protective strip, the latter reduces propagation of the hot gas vertically and transversely to the direction of extent of the frame strip and thus prevents uncontrolled propagation of the hot gas in the interior space of the accumulator housing. Rather, the at least one protective strip in the form of a U profile forms a degassing channel oriented along the frame strip in the direction of at least one side wall of the accumulator housing.

With particular preference, the support apparatus has two protective strips at a spacing from one another on the frame strip of the holding frame, which are designed to conduct the hot gas along the frame strip in the direction of mutually opposite ends of the frame strip, and, for this, end faces, which are arranged in the region of the ends of the frame strips, of the protective strips are open and mutually facing end faces of the protective strips each have a covering. Each protective strip thus carries the hot gas toward one end of the frame strip, with the result that the hot gas is conducted toward both side walls of the accumulator housing and discharged to either side of the support apparatus.

The present disclosure also relates to an electric motor vehicle having at least one traction accumulator according to the invention. The motor vehicle is in particular in the form of a passenger car.

The embodiments presented in relation to the support apparatus according to the invention and their advantages apply correspondingly to the traction accumulator according to the invention and to the motor vehicle according to the present disclosure.

Further features of the present disclosure emerge from the claims, the figures and the description of the figures. The features and combinations of features that are mentioned in the description above and the features and combinations of features that are mentioned in the description of the figures below and/or are shown solely in the figures can be used not only in the respective specified combination but also in other combinations or on their own.

### BRIEF DESCRIPTION OF THE DRAWINGS

The invention will now be explained in more detail on the basis of a preferred exemplary embodiment and with reference to the drawings, in which:

FIG. 1 shows a perspective illustration of a traction accumulator for a motor vehicle;

FIG. 2 shows an illustration in longitudinal section through the traction accumulator according to FIG. 1;

FIG. 3 shows an illustration in cross section through the traction accumulator according to FIG. 1; and

FIG. 4 shows a perspective illustration of a support apparatus of the traction accumulator.

### DETAILED DESCRIPTION OF THE DRAWINGS

In the figures, identical and functionally identical elements are provided with the same reference signs.

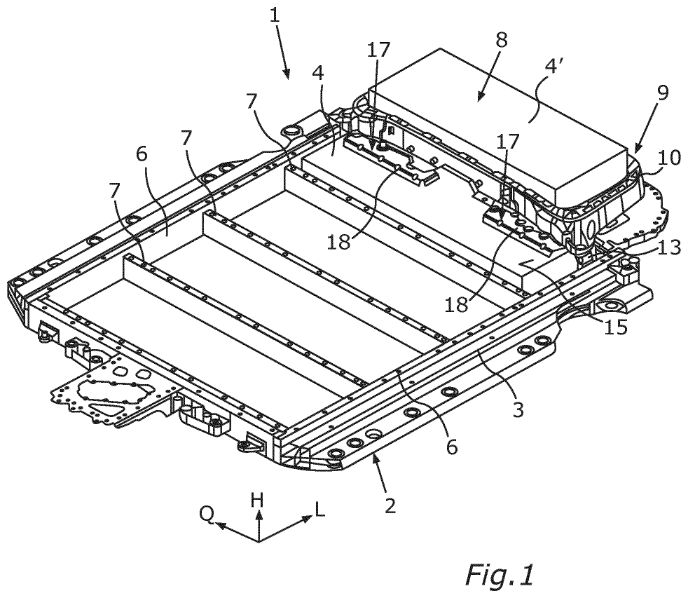

FIG. 1 shows a perspective illustration of a traction accumulator 1 for an electric or hybrid vehicle. The traction accumulator 1 has an accumulator housing 2, of which only a trough-like housing lower part 3, or a housing bottom, is shown here. To close off the accumulator housing 2, a housing upper part, or a housing cover, which is not shown here, can be placed onto the housing lower part 3. As an alternative, the housing lower part 3 may be fastened to a body of the motor vehicle, so that the body closes off the accumulator housing 2. The accumulator housing 2 contains cell modules 4, of which only one cell module 4 is shown here, on a bottom region 5 of the housing lower part 3 in a first, lower plane. The housing lower part 3 has two longitudinal struts 6, which are at a spacing in the vehicle transverse direction Q and here also form side walls of the accumulator housing 2, and multiple transverse struts 7, which are at a spacing in the vehicle longitudinal direction L and to which cell module frames, not shown here, of the cell modules 4 can be fastened to hold the cell modules 4 in the accumulator housing 2.

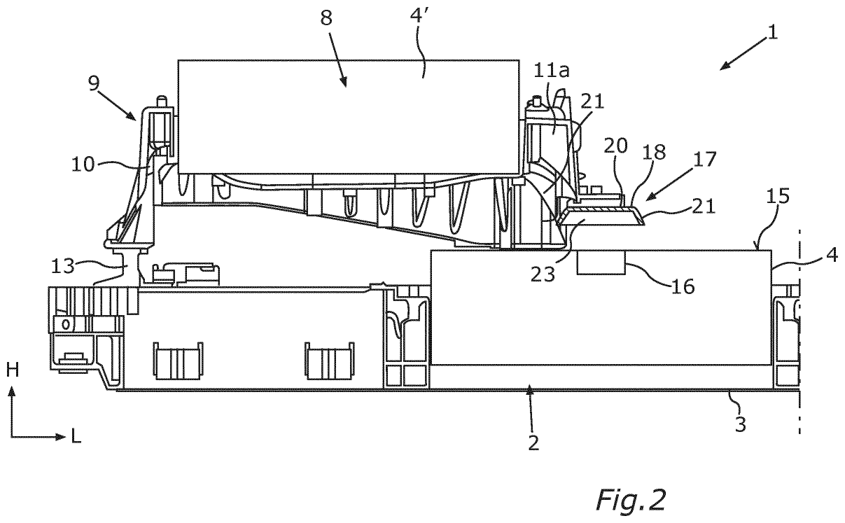

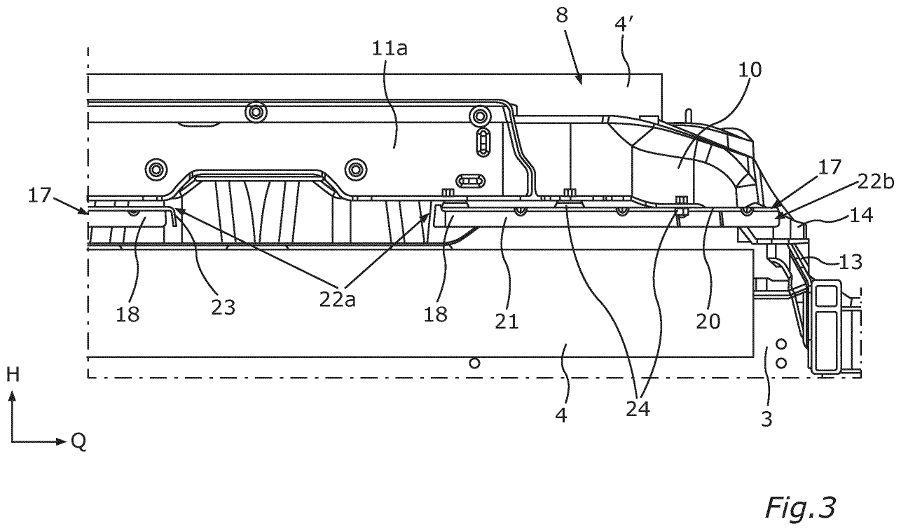

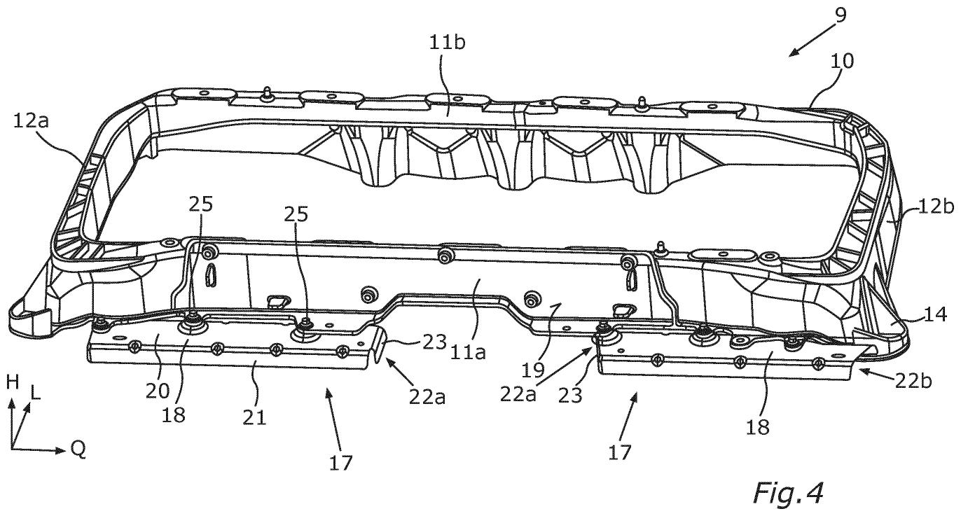

The traction accumulator 1 also has at least one accumulator component 8, which, as is also shown on the basis of the sectional illustrations of the traction accumulator 1 in FIG. 2 and FIG. 3, is arranged in a second, upper plane vertically above the first plane in the height direction H. The accumulator component 8 is in the form of a further cell module 4′ in this case. To hold the accumulator component 8, the traction accumulator 1 has a support apparatus 9, which has a bottomless holding frame 10 for receiving the accumulator component 8. The support apparatus 9 is shown in a perspective illustration in FIG. 4. The rectangular holding frame 10 has multiple frame strips 11a, 11b, 12a, 12b, the frame strips 11a, 11b forming longitudinal sides of the holding frame 10, which in this case extend in the vehicle transverse direction Q, and the frame strips 12a, 12b forming short sides of the holding frame 10, which in this case extend in the vehicle longitudinal direction L. The support apparatus 10 may also have feet-like support elements 13 which are fastened, for example screwed, to fastening tabs 14 of the holding frame 10 and to the housing lower part 3, for example to the longitudinal struts 6 and/or transverse struts 7, to arrange the holding frame 10 above the cell module 4.

By means of the support apparatus 9, the accumulator component 8 is positioned with respect to the cell module 4 such that it is vertically offset from the cell module 4, which is to say offset above it in the height direction H, and horizontally offset from the cell module, in this case along the vehicle longitudinal direction L. As a result, the accumulator component 8 only partially overlaps an upper side 15 of the cell module 4. The cell module 4 has a multiplicity of, in this case prismatic cells, the degassing elements of which form a degassing region 16 on the upper side 15 of the cell module 4. The degassing region 16 is not covered by the accumulator component 8 arranged above it. The accumulator component 8 is thus arranged to the side of, or next to, the degassing region 16. In the event of an ejection of hot gas from a cell of the cell module 4 owing to a fault, hot gas rises from the degassing region 16 in the height direction H. In order to prevent the hot gas from damaging the accumulator component 8, the support apparatus 9 has a hot-gas collecting device 17, which is designed to collect and discharge the hot gas before it reaches the accumulator component 8.

The hot-gas collecting device 17 in this case has two protective strips 18, which are at a spacing from one another on the frame strip 11a and protrude, or project, from an outer side 19 of the frame strip 11a in the longitudinal direction L. As a result, the protective strips 18 are in line with and thus at least partially cover the degassing region 16 in the height direction H. The protective strips 18 are thus arranged in an intermediate plane between the first and the second plane. The protective strips 18 are in the form of protective metal sheets which are in the form of a U profile and have a cover region 20, overlapping the degassing region 16, for preventing vertical propagation of the hot gas and two side regions 21 for preventing horizontal propagation of the hot gas transversely to a direction of extent of the protective strips 18 in the vehicle longitudinal direction L. The protective strips 18 each have a covering 23 on their mutually facing, inner end faces 22a. This prevents the hot gas collected in the protective strip 18 from exiting the protective strips 18 via the inner end faces 22a and entering the interior space of the accumulator housing 2. Outer end faces 22b of the protective strips 18, which are arranged in the region of the short-side frame strips 12a, 12b, are open. The hot gas conducted along the direction of extent hot gas can therefore exit the protective strips only at the open end faces 22b and is thus discharged in the region of the lateral edges of the holding frame 10. The protective strips 18 moreover have rivet nuts 24, via which the protective strips 18 are fastened to and suspended from the holding frame 10 by means of screws 25.

1.-13. (canceled)

14. A support apparatus for at least one accumulator component of a traction accumulator, which is designed to hold the at least one accumulator component vertically above and horizontally only partially overlapping at least one cell module of the traction accumulator in an accumulator housing of the traction accumulator, comprising:
a holding frame configured to receive the at least one accumulator component and to partially overlapping an upper side of the at least one cell module in a manner horizontally offset from a degassing region, which is on the upper side, of the at least one cell module,
a hot-gas collecting device having at least one protective strip, which is fastened to the holding frame, protrudes from an outer side of a frame strip of the holding frame, and extends at least partially along the frame strip, for covering the degassing region, which protective strip is designed to collect a hot gas exiting the degassing region from at least one cell of the cell module and keep it away from the at least one accumulator component.

15. The support apparatus according to claim 14, wherein the at least one protective strip is in the form of a stamped and bent sheet-metal part.

16. The support apparatus according to claim 14, wherein the holding frame is in the form of a cast aluminum structure.

17. The support apparatus according to claim 14, wherein the at least one protective strip is fastened to the holding frame by means of screws.

18. The support apparatus according to claim 14, wherein the at least one protective strip is designed to carry the hot gas along the frame strip toward an end face, which is arranged in the region of an end of the frame strip, of the protective strip and thus discharge it to the side of the support apparatus.

19. The support apparatus according to claim 18, wherein the at least one protective strip for conducting the hot gas along the frame strip is in the form of a U profile.

20. The support apparatus according to claim 14, wherein the support apparatus has two protective strips which are at a spacing from one another on the frame strip of the holding frame and are designed to conduct the hot gas along the frame strip in the direction of mutually opposite ends of the frame strip, and, for this, end faces, which are arranged in the region of the ends of the frame strips, of the protective strips are open and mutually facing end faces of the protective strips have a covering.

21. The support apparatus according to claim 14, wherein the support apparatus has feet-like support elements, which are connected to the holding frame and can be connected to the accumulator housing.

22. A traction accumulator for a motor vehicle, comprising:
at least one cell module having a multiplicity of cells and a degassing region with cell degassing elements for discharging a hot gas from a cell housing of the cells being located on an upper side of the cell module;
at least one accumulator component; and
at least one support apparatus according to claim 14;
the at least one accumulator component being arranged in the holding frame and partially overlaps the upper side of the cell module in a manner horizontally offset from the degassing region, and the at least one protective strip being at a vertical spacing from and horizontally overlapping the degassing region.

23. The traction accumulator according to claim 22, wherein the at least one accumulator component is in the form of a further cell module.

24. The traction accumulator according to claim 22, wherein the at least one cell module is in the form of a cell stack composed of prismatic cells stacked in a stack direction and the degassing region extends on the top side in the form of a strip in the stack direction, the at least one protective strip being arranged on a frame strip, which overlaps the upper side and extends in the stack direction, of the holding frame and protrudes from the outer side of the frame strip transversely to the stack direction.

25. The traction accumulator according to claim 24, wherein the traction accumulator has an accumulator housing, which contains the at least one cell module and the at least one accumulator component, the holding frame being fastened to a housing part of the accumulator housing via feet-like support elements.

26. A motor vehicle having at least one traction accumulator according to claim 22.
